(19) United States
(12) Patent Application Publication
(10) Pub. No.: US 2018/0219767 A1
(43) Pub. Date: Aug. 2, 2018

(54) COMMUNICATION RELAY DEVICE, SERVER, IMAGE PROCESSING UNIT AND NON-TRANSITORY RECORDING MEDIUM

(71) Applicant: KONICA MINOLTA, INC., Tokyo (JP)

(72) Inventor: Yoshinobu FURUYA, Amagasaki-shi (JP)

(73) Assignee: KONICA MINOLTA, INC., Tokyo (JP)

(21) Appl. No.: 15/880,904

(22) Filed: Jan. 26, 2018

(30) Foreign Application Priority Data
Jan. 30, 2017 (JP) 2017-013946

(51) Int. Cl. H04L 12/707; H04L 12/26

(52) U.S. Cl. CPC H04L 45/22; H04L 41/22; H04L 43/04

(57) ABSTRACT

A communication relay device connected in parallel with a router that connects an external network and an internal network, includes a hardware processor that: determines if a packet received over the external network is blocked by the router when the packet is received; and sends a responding instruction to a device connected to the internal network based on the received packet if the received packet is determined to be the packet that is blocked by the router.

The entire disclosure of Japanese patent application No. 2017-013946 filed on Jan. 30, 2017, is incorporated herein by reference in its entirety.

### BACKGROUND

### Technological Field

The present invention relates to a communication relay device, a server, an image processing unit and a non-transitory recording medium. The present invention more specifically relates to a technique for transmitting a packet from an external network that is blocked by a router to an internal network.

### Description of the Related Art

There may be a network system including a first network and a second network connected to each other via a router. In the network system, a device on the first network may send a command as a broadcast command or a multicast command to search a device such as a printer. The router blocks the broadcast packet or the multicast packet. The command from the first network is not transmitted to the second network. The device connected to the first network is not allowed to detect the device connected to the second network.

In order to avoid this, a probe device is conventionally installed on the second network. The device connected to the first network enables a unicast transmission for a command to the probe device so that the command is passed through the router and distributed to the second network. This known technique is introduced for example in Japanese Patent Application Laid-Open No. JP 2004-5553 A. According to the known technique, once the command is received from the first network, the probe device broadcasts the command to the second network. The device connected to the second network may receive the broadcast command. It then sends response information to the probe device. The probe device enables the unicasting of the response information collected from the device on the second network to the device on the first network. As a result, the device connected to the first network may detect the device connected to the second network.

According to the known technique, however, in the case where the device connected to the first network runs a search for the device connected to the second network, unicast transmission addressing an IP address of the probe device is required. It is assumed that a printer driver, for example, runs a search for the printer upon its booting. In such a case, the printer driver has to have an advance registration of the IP address of the probe device. This is bothersome for users. Especially recently, a place such as an office has a large network. Multiple networks are connected to each other via the router. When the printer driver runs a search for the printer connected to every network of the multiple networks, the printer driver has to have the advance registration of every IP address of the prove device on the multiple networks. A working burden on the users for the advance registration becomes huge.

### SUMMARY

The present invention is intended to solve the above problems. Thus, the present invention is intended to provide a communication relay device, a server, an image processing unit and a non-transitory recording medium capable of obtaining response information in response to a broadcast command or a multicast command without an advance registration with a printer driver, for instance.

First, the present invention is directed to a communication relay device connected in parallel with a router that connects an external network and an internal network.

To achieve at least one of the abovementioned objects, according to an aspect of the present invention, the communication relay device reflecting one aspect of the present invention comprises a hardware processor that: determines if a packet received over the external network is blocked by the router when the packet is received; and sends a responding instruction to a device connected to the internal network based on the received packet if the received packet is determined to be the packet that is blocked by the router.

Second, the present invention is directed to a server.

To achieve at least one of the abovementioned objects, according to an aspect of the present invention, the server reflecting one aspect of the present invention comprises a communication relay device according to claim 1; and a router connected in parallel with the communication relay device with connecting an external network and an internal network.

Third, the present invention is directed to an image processing unit.

To achieve at least one of the abovementioned objects, according to an aspect of the present invention, the image processing unit reflecting one aspect of the present invention comprises a server according to claim 14; and an image processing device connected with the server over an internal network. The image processing device sends response information to an address designated in a responding instruction when receiving the responding instruction from a communication relay device in the server over the internal network.

Fourth, the present invention is directed to a non-transitory recording medium storing a computer readable program to be executed by a communication relay device that is connected in parallel with a router that connects an external network and an internal network.

To achieve at least one of the abovementioned objects, according to an aspect of the present invention, the non-transitory recording medium reflecting one aspect of the present invention stores the computer readable program, execution of the computer readable program by the communication relay device causing the communication relay device to perform: (1) determining if a packet received over the external network is blocked by the router when the packet is received; and (2) sending a responding instruction to a device connected to the internal network based on the received packet if the received packet is determined as the packet that is blocked by the router.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary configuration of an image processing system;

FIG. 2 illustrates a block diagram showing an example of a detailed functional structure of a communication relay device;

FIG. 3 illustrates a transmission manner of response information by an image processing device;

FIGS. 4A and 4B illustrate examples of a screen for registration of packet determination information;

FIGS. 5A and 5B illustrate examples of the screen for registration of the packet determination information;

FIG. 6 illustrates an example of the packet determination information;

FIG. 7 illustrates an example of data structure of a packet received by a server from a company network;

FIG. 8 illustrates a flow diagram explaining an exemplary procedure of a main process performed by the communication relay device;

FIG. 9 illustrates a flow diagram explaining an exemplary procedure of a responding instruction determination in detail; and

FIG. 10 illustrates an exemplary configuration of the image processing system with the company network including multiple networks.

### DETAILED DESCRIPTION OF EMBODIMENTS

Hereinafter, one or more embodiments of the present invention will be described with reference to the drawings. However, the scope of the invention is not limited to the disclosed embodiments.

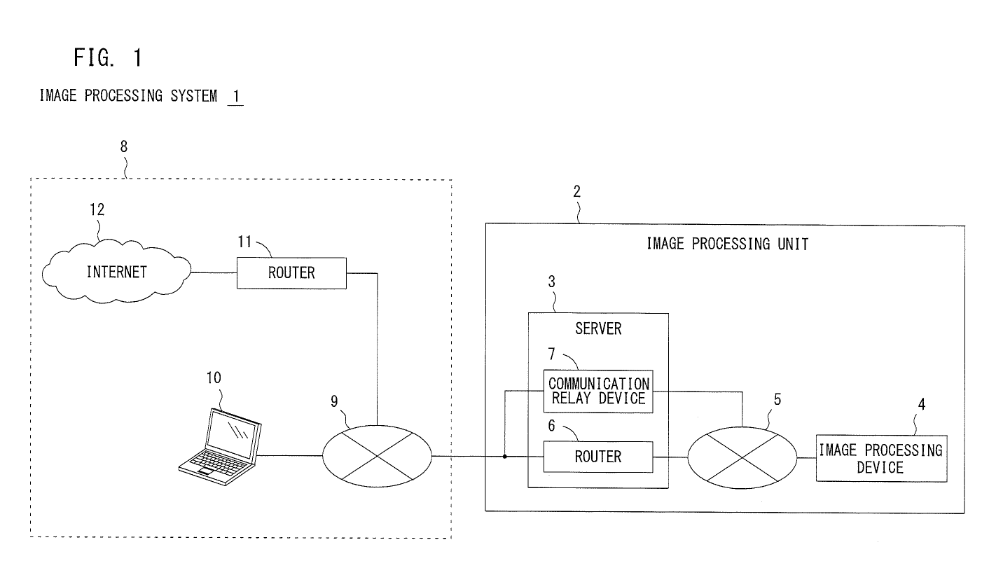

FIG. 1 illustrates an exemplary configuration of an image processing system 1 in which the present preferred embodiment of the present invention may be practiced. The image processing system 1 includes an image processing unit 2. The image processing unit 2 is connected to an external network 8. The external network 8 includes a company network 9, an information processing device 10, a router 11 and an internet 12. The company network 9 such as a LAN (Local Area Network) is installed in a place such as an office, for example. The information processing device 10 and the router 11 are connected to the company network 9. The internet 12 is connected to the router 11. The information processing device 10 is constructed by a personal computer, tablet terminal or a smartphone, for instance. The router 11 includes a firewall function, for example. The image processing unit 2 is connected to the company network 9 of the external network 8. In the example of FIG. 1, there is only the single information processing device 10 connected to the company network 9. The number of the network connected information processing device 10 is not always one. It may be more than one information processing devices 10. The company network 9 may be a complex network including multiple networks connected to each other.

The information processing device 10 connected to the company network 9 is with an application installed therein. The application may be a printer driver, for instance, to construct a print job that may be processed at an image processing device 4. The information processing device 10 runs the application, and the application sends a search command to run a search for a printer to the company network 9 as a broadcast command or a multicast command. The information processing device 10 obtains response information in response to the search command, thereby detecting the printer to which a print job may be addressed.

A server 3 and the image processing device 4 are included in a single housing of the image processing unit 2. The server 3 and the image processing device 4 connected to each other over an internal network 5 are in communication with each other. The image processing device 4 may be a MFP (Multifunction Peripherals) including multiple functions such as a scan function, a print function and/or a fax function, for instance. The image processing device 4 may process a job designated by a user and/or a job received over the internal network 5. The server 3 may control the image processing device 4 connected to the internal network 5. Once the server 3 receives the job addressed to the image processing device 4 from the company network 9, for example, the server 3 outputs the job to the image processing device 4 over the internal network 5.

The server 3 includes a router 6 and a communication relay device 7 connected between the company network 9 and the internal network 5. In the present preferred embodiment, each of the router 6 and the communication relay device 7 becomes operative once a predetermined program is executed on the server 3, for example.

The router 6 connects the company network 9 and the internal network 5 to each other as a separate network. The router 6 sends a packet from the company network 9 to the internal network 5 and/or sends a packet from the internal network 5 to the company network 9. The router 6 includes a firewall function. The router 6 may receive a broadcast packet or a multicast packet from the company network 9. In this case, the router 6 blocks the packet not to transmit to the internal network 5. This helps reduction of a traffic of the internal network 5. Also, a security level of the internal network 5 may be maintained. As a result, however, the router 6 blocks a broadcast command or a multicast command such as a search command from the information processing device 10 on the company network 9.

The communication relay device 7 is connected in parallel with the router 6 between the company network 9 and the internal network 5. The communication relay device 7 may receive the same packet as the packet received by the router 6. The communication relay device 7 analyzes the packet from the company network 9, thereby determining if the received packet should be blocked by the router 6. Specifically, in the case where the received packet from the company network 9 is the broadcast packet or the multicast packet, the communication relay device 7 determines the received packet is the packet that should be blocked by the router 6. When determining the received packet is the packet that should be blocked by the router 6, the communication relay device 7 transmits the packet to the internal network 5. The packet that should be blocked by the router 6 is delivered to the image processing device 4.

If all of the broadcast packets and/or the multicast packets from the company network 9 are distributed to the internal network 5 by the communication relay device 7, this leads an increased traffic of the internal network 5, and a reduction of the communication efficiency. In addition, the security level of the internal network 5 will be declined. If determining that the received packet is the packet that should be blocked by the router 6, the communication relay device 7 preferably determines whether a response from the image processing device 4 is required for the received packet. When it is determined that the response from the image processing device 4 is required for the received packet, the communication relay device 7 enables the image processing device 4 to send response information. The communication relay device 7 is discussed in detail next.

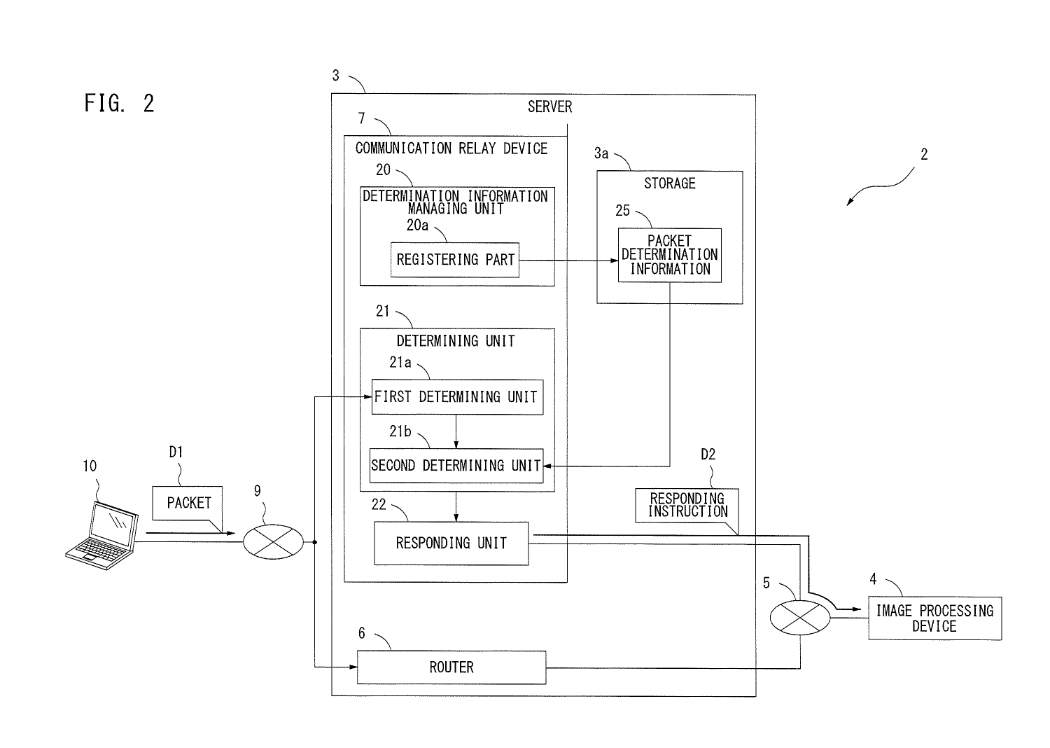

FIG. 2 illustrates a block diagram showing an example of a detailed functional structure of the communication relay device 7. The communication relay device 7 includes a determination information managing unit 20, a determining unit 21 and a responding unit 22 as illustrated in FIG. 2. The server 3 serves as the communication relay device 7 that runs a predetermined program so that each part becomes operative.

The determination information managing unit 20 manages packet determination information 25. The packet determination information 25 is referred when the communication relay device 7 determines the received packet from the company network 9. The packet determination information 25 is stored in a non-volatility storage 3a provided with the server 3, for instance, and managed by the determination information managing unit 20.

The determination information managing unit 20 includes a registering part 20a. The registering part 20a registers information to determine if the packet requires the response from the image processing device 4 with the packet determination information 25 in the storage 3a. The registering part 20a becomes operative when a registration instruction to the communication relay device 7 is received from the information processing device 10 operated by an administrator, for example. The registering part 20a provides the information processing device 10 operated by the administrator with a screen for the registration of the packet that requires the response from the image processing device 4. The registering part 20 registers various types of information with the packet determination information 25 based on the administrator's operations.

The determining unit 21 determines a packet D1 sent from the information processing device 10, for instance, and the one received over the company network 9. The determining unit 21 includes a first determining unit 21a and a second determining unit 21b.

The first determining unit 21a determines the packet D1 received over the company network 9 is the packet that is blocked by the router 6. Specifically, the first determining unit 21a determines if the packet D1 received over the company network 9 is the broadcast packet or the multicast packet. If the received packet D1 is the broadcast packet or the multicast packet, the first determining unit 21a determines the packet D1 is the packet that is blocked by the router 6. For the broadcast packet, all the bits of the host address of the IP address set as a destination are set to “1.” For the multicast packet, an address in a scope from “239.0.0.0” to “239.255.255.255” is specified as the IP address set as the destination, for example. The first determining unit 21a may determine whether the IP address set as the destination of the packet D1 received from the company network 9 is the broadcast address or the multicast address, thereby determining if the packet is blocked by the router 6.

The second determining unit 21b becomes operative when the first determining unit 21a determines that the received packet is blocked by the router 6. The second determining unit 21b determines if the image processing device 4 should give a response to the packet D1 blocked by the router 6 based on the packet determination information 25 stored in the storage 3a. The second determining unit 21b may determine the packet requires the response from the image processing device 4, it brings the responding unit 22 into operation.

The responding unit 22 outputs a responding instruction D2 to the image processing device 4 over the internal network 5 as illustrated in FIG. 2 when the second determining unit 21b determines that the image processing device 4 should give the response to the packet. The responding unit 22 sends the responding instruction D2 to the internal network 5 as the unicast packet addressed to the image processing device 4. The image processing device 4 may receive the responding instruction D2 from the responding unit 22 instead of the packet D1 blocked by the router 6.

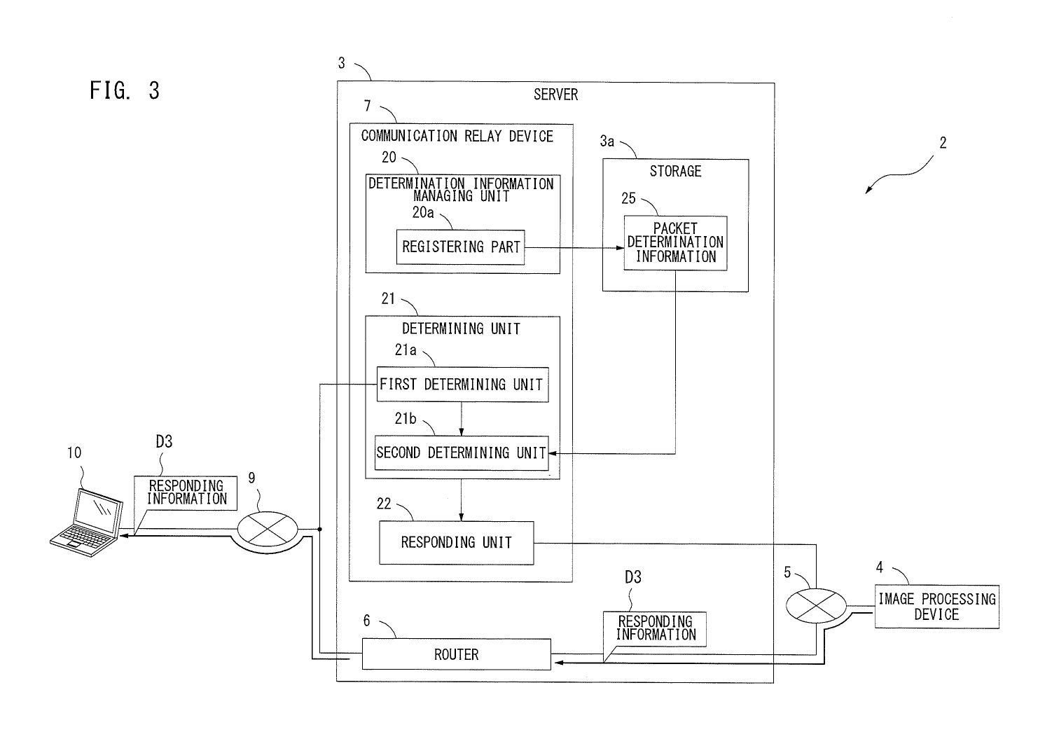

When sending the responding instruction D2, the responding unit 22 adds a command included in the packet D1, information (for instance, the IP address) to specify the information processing device 10 that is a sender of the packet D1, and an order instructing via the router 6 to respond to the information processing device 10 that is the sender of the packet D1 to the responding instruction D2. The image processing device 4 may receive the command such as the search command from the information processing device 10 with the responding instruction D2. The image processing device 4 then may give the response to the command to the information processing device 10. The image processing device 4 enables unicasting of response information D3 to the information processing device 10 via the router 6 based on the responding instruction D2, as illustrated in FIG. 3.

The information processing device 10 may obtain the response information D3 in response to the broadcast or the multicast command such as the broadcast or multicast search command from the image processing device 4 connected to the internal network 5 in the image processing unit 2. Specifically, even without the advance registration of information such as the IP address of the image processing device 4 and/or the address of the internal network 5 with the application such as the printer driver, the information processing device 10 may obtain the response information D3 from the image processing device 4.

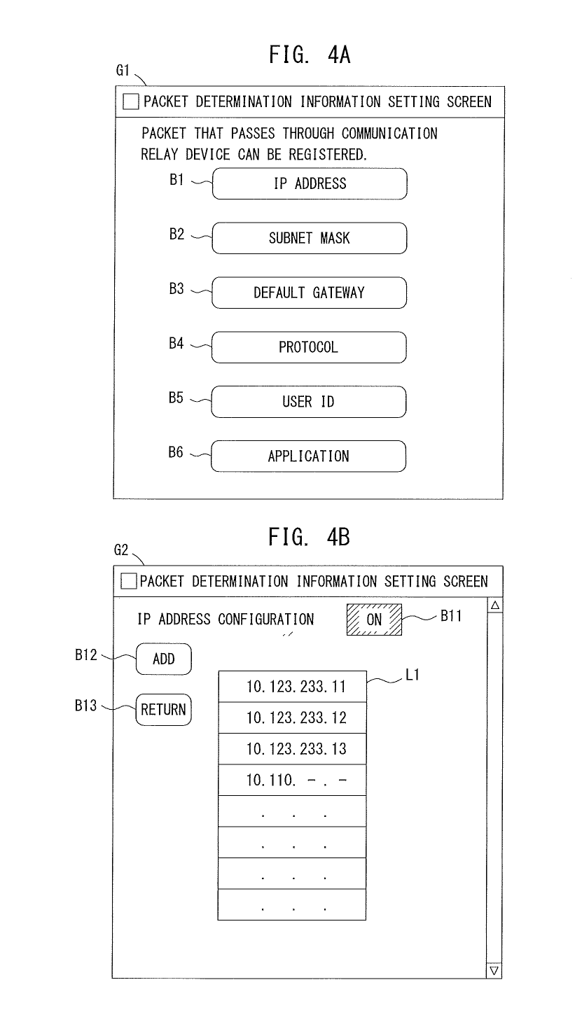

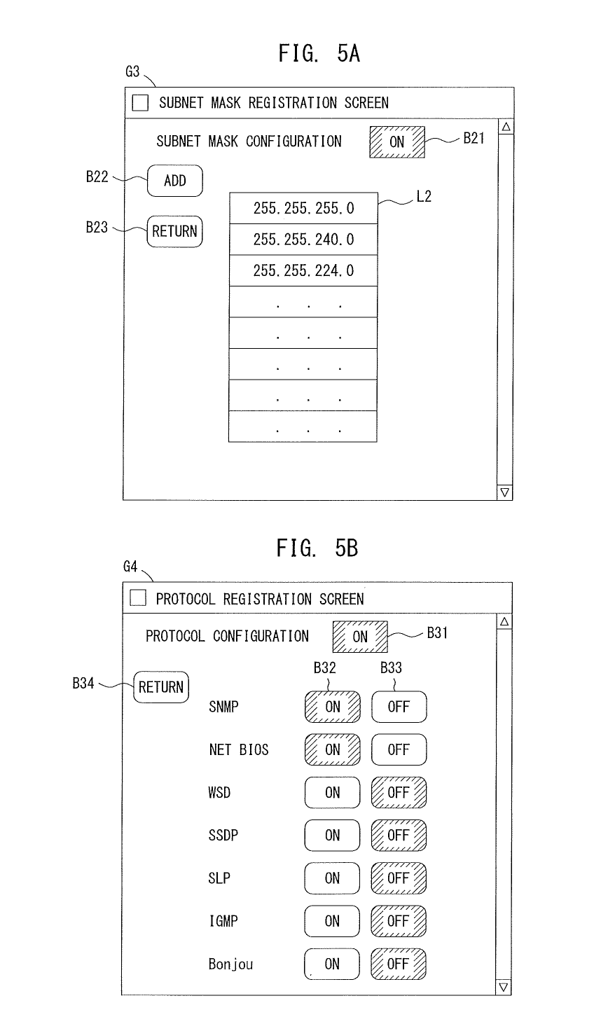

Information registered with the packet determination information 25 is explained next. FIGS. 4A, 4B, 5A and 5B illustrate examples of a screen for registration of the packet determination information 25. The screen is provided by the registering part 20a. FIG. 4A illustrates a top screen G1 appeared when the administrator registers the packet determination information 25. Information on the IP address, a subnet mask, a default gateway, a protocol, a user ID and an application may be registered with the packet determination information 25 as the information to determine the packet D1 sent from the information processing device 10. The top screen G1 is a menu screen for selecting which of the aforementioned information is to be registered. Specifically, the top screen G1 includes multiple buttons B1 to B6. The administrator selects one of the multiple buttons B1 to B6 so that a screen for registering the corresponding information appears.

FIG. 4B illustrates an example of a screen G2 for registering the IP address. A button B11, an area L1, buttons B12 and B13 are shown on the screen G2. The button B11 is selected for configuring whether or not to determine the IP address of the sender when determining if the packet D1 requires the response from the image processing device 4. A list of the registered IP addresses are shown in the area L1. The button B12 is selected to add the new IP address in the list in the area L1. The button B13 is selected to return to the top screen G1. The administrator selects the button on the screen G2, and he or she may configure to enable or disable the function to determine the IP address of the sender when determining if the packet D1 requires the response from the image processing device 4. Also, the administrator may register the IP address of the sender to identify the packet D1 that requires the response from the image processing device 4.

FIG. 5A illustrates an example of a screen G3 for registering the subnet mask. A button B21, an area L2, buttons B22 and B23 are shown on the screen G3. The button B21 is selected for configuring whether or not to determine the subnet mask of the sender when determining if the packet D1 requires the response from the image processing device 4. A list of the registered subnet masks are shown in the area L2. The button B22 is selected to add the new subnet mask in the list in the area L2. The button B23 is to return to the top screen G1. The administrator selects the button on the screen G3, and he or she may configure to enable or disable the function to determine the subnet mask of the sender when determining if the packet D1 requires the response from the image processing device 4. Also, the administrator may register the subnet mask of the sender to identify the packet D1 that requires the response from the image processing device 4.

FIG. 5B illustrates an example of a screen G4 for registering the protocol. Buttons B31 to B34 are shown on the screen G4. The button B31 is selected for configuring whether or not to determine the protocol of the packet D1 when determining if the packet D1 requires the response from the image processing device 4. The buttons B32 and B33 are selected to enable or disable the setting for each protocol that may be processed by the image processing device 4. The button B34 is to return to the top screen G1. The administrator selects the button on the screen G4, and he or she may configure to enable or disable the function to determine the protocol of the packet D1 when determining if the packet D1 requires the response from the image processing device 4. Also, the administrator may individually register the protocol to identify the packet D1 that requires the response from the image processing device 4.

Besides the above-described screens, the registering part 20a may provide screens to register the default gateway which sends the packet D1, the user ID of the sender and the application of the sender to determine if the packet D1 requires the response from the image processing device 4. The registering part 20a registers the various types of information with the packet determination information 25 based on the administrator's operations on each screen.

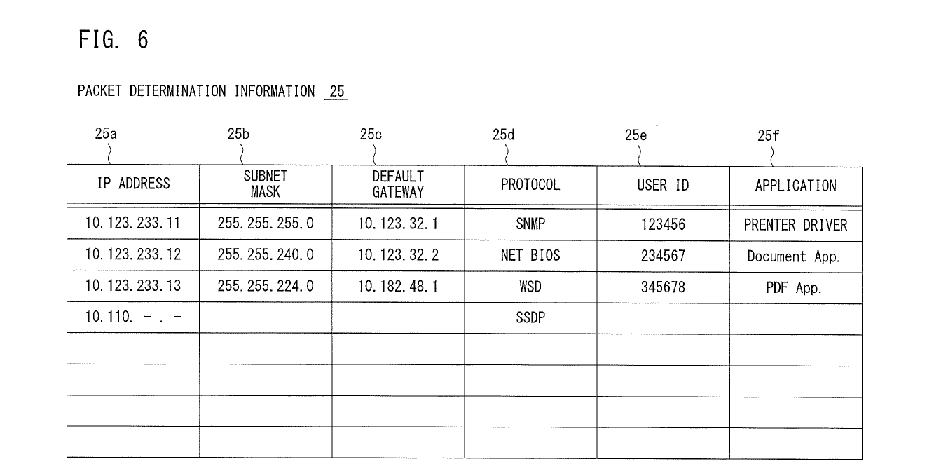

FIG. 6 illustrates an example of the packet determination information 25. The packet determination information 25 is table information including items, an IP address 25a, a subnet mask 25b, a default gateway 25c, a protocol 25d, a user ID 25e and an application 25f. The information configured by the administrator is registered as each item. The information on the IP address of the sender to which the response should be sent by outputting the responding instruction D2 to the image processing device 4 and the IP address specified by the administrator is registered as the item, the IP address 25a, for instance. The packet D1 received from the company network 9 is analyzed based on the packet determination information 25 as illustrated in FIG. 6, and it may be determined if the image processing device 4 should send the response to the packet.

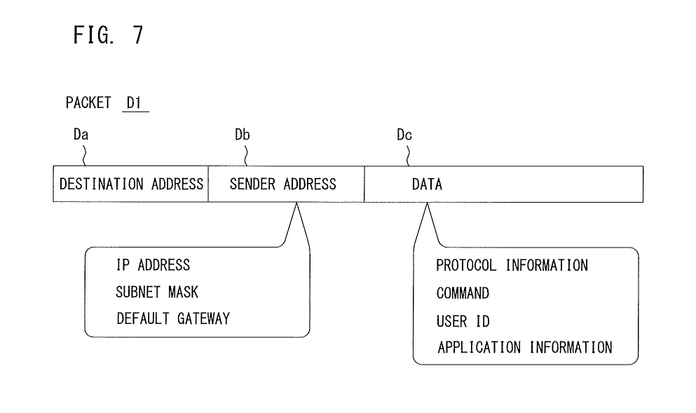

FIG. 7 illustrates an example of data structure of the packet D1 received by the server 3 from the company network 9. The packet D1 includes a destination address Da, a sender address Db and data Dc. In the case where the packet D1 is the broadcast packet or the multicast packet, the broadcast address or the multicast address is included in the destination address Da, as discussed earlier. The first determining unit 21a thus determines the destination address Da. The second determining unit 21b analyzes the sender address Db and the data Dc to determine if the packet requires the response from the image processing device 4. Specifically, the sender address Db, as illustrated in FIG. 7, includes information on the IP address, the subnet mask and the default gateway of the sender. The data Dc includes protocol information, the command, the user ID and the application information. At least one of the information included in the sender address Db and the data Dc of the packet D1 may match with the information registered with the packet determination information 25. In this case, the second determining unit 21b determines the packet D1 requires the response from the image processing device 4. Once determining the packet requires the response from the image processing device 4 based on the sender address Db and the data Dc, the second determining unit 21b brings the responding unit 22 into operation to send the responding instruction D2 to the internal network 5. When the broadcast packet D1 or the multicast packet D1 is received from the company network 9, the communication relay device 7 determines if the packet D1 requires the response from the image processing device 4 based on the packet determination information 25 registered in advance by the administrator. Only if it is determined that the packet requires the response from the image processing device 4, the image processing device 4 is enabled to send the response information D3. In other words, when it is determined that the packet does not require the response from the image processing device 4, the responding instruction D2 to the image processing device 4 is not sent. This avoids increase in the traffic of the internal network 5 and decline of the communication efficiency.

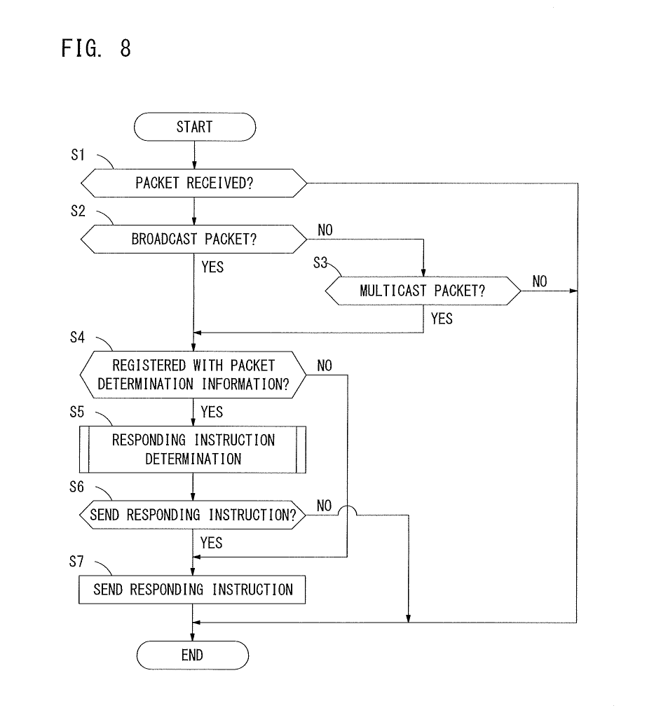

The detailed procedure of a process performed in the communication relay device 7 is explained next. FIG. 8 illustrates a flow diagram explaining an exemplary procedure of a main process performed by the communication relay device 7. Once the communication relay device 7 boots in the server 3, the process illustrated in FIG. 8 is repeatedly performed by the communication relay device 7. Upon a start of the process, the communication relay device 7 determines whether or not the packet D1 is received over the company network 9 (step S1). The packet D1 may not be received (when a result of step S1 is NO). The process is then complete.

In the case where the packet D1 is received (when a result of step S1 is YES), the communication relay device 7 brings the first determining unit 21a into operation to determine if the received packet D1 is the broadcast packet (step S2). The received packet D1 may not be the broadcast packet (when a result of step S2 is NO). The first determining unit 21a then further determines if the received packet D1 is the multicast packet (step S3). The received packet D1 may be neither the broadcast packet nor the multicast packet (when results of steps S2 and S3 are NO). The communication relay device 7 then completes the process.

The received packet D1 may be either the broadcast packet or the multicast packet (when a result of step S2 or S3 is YES). The communication relay device 7 then brings the second determining unit 21b into operation to determine if the information to determine the packet D1 is registered with the packet determination information 25 stored in the storage 3a (step S4). When the information to determine the packet D1 is registered with the packet determination information 25 (when a result of step S4 is YES), the communication relay device 7 proceeds a responding instruction determination to determine the packet D1 based on the packet determination information 25 (step S5). A process to determine if the received packet D1 requires the response from the image processing device 4 is carried out as the responding instruction determination.

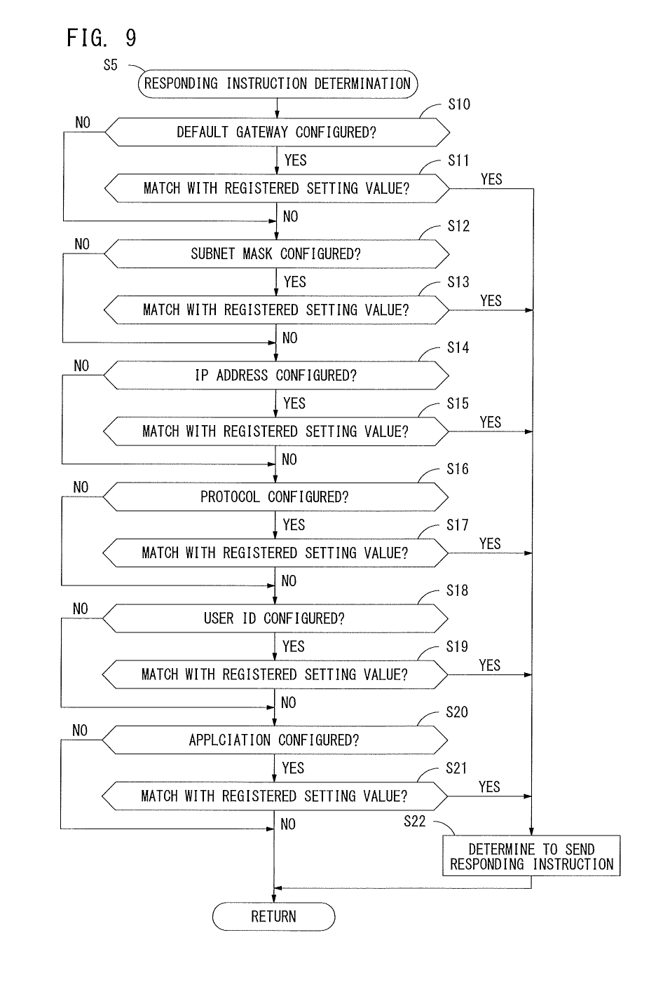

FIG. 9 illustrates a flow diagram explaining an exemplary procedure of the responding instruction determination in detail. The responding instruction determination is performed by the second determining unit 21b.

Once the responding instruction determination is started, the communication relay device 7 determines if the information on the default gateway is included in the packet determination information 25 (step S10). The information on the default gateway may be included (when a result of step S10 is YES). The communication relay device 7 then determines if the information on the default gateway included in the received packet D1 and the information registered with the packet determination information 25 match with each other (step S11). When the information in the received packet D1 matches with the information registered with the packet determination information 25 (when a result of step S11 is YES), the communication relay device 7 determines to send the responding instruction D2 to the image processing device 4, which has a connection to the internal network 5 (step S22). The information in the received packet D1 may not match with the information registered with the packet determination information 25 (when a result of step S11 is NO). The communication relay device 7 then proceeds the process in step S12. Also when the information on the default gateway is not included with the packet determination information 25 (when a result of step S10 is NO), the communication relay device 7 proceeds the process in step S12.

In step S12, the communication relay device 7 determines if the information on the subnet mask is included in the packet determination information 25 (step S12). The information on the subnet mask may be included (when a result of step S12 is YES). The communication relay device 7 then determines if the information on the subnet mask included in the received packet D1 and the information registered with the packet determination information 25 match with each other (step S13). When the information in the received packet D1 matches with the information registered with the packet determination information 25 (when a result of step S13 is YES), the communication relay device 7 determines to send the responding instruction D2 to the image processing device 4, which has a connection to the internal network 5 (step S22). The information in the received packet D1 may not match with the information registered with the packet determination information 25 (when a result of step S13 is NO). The communication relay device 7 then proceeds the process in step S14. Also when the information on the subnet mask is not included in the packet determination information 25 (when a result of step S12 is NO), the communication relay device 7 proceeds the process in step S14.

In step S14, the communication relay device 7 determines if the information on the IP address is included in the packet determination information 25 (step S14). The information on the IP address may be configured (when a result of step S14 is YES). The communication relay device 7 then determines if the information on the IP address of the sender included in the received packet D1 and the information registered with the packet determination information 25 match with each other (step S15). When the IP address of the sender in the received packet D1 matches with the information registered with the packet determination information 25 (when a result of step S15 is YES), the communication relay device 7 determines to send the responding instruction D2 to the image processing device 4, which has a connection to the internal network 5 (step S22). The IP address of the sender in the received packet D1 may not match with the information registered with the packet determination information 25 (when a result of step S15 is NO). The communication relay device 7 then proceeds the process in step S16. Also when the IP address of the sender is not included in the packet determination information 25 (when a result of step SM is NO), the communication relay device 7 proceeds the process in step S16.

In step S16, the communication relay device 7 determines if the information on the protocol is included in the packet determination information 25 (step S16). The information on the protocol may be included (when a result of step S16 is YES). The communication relay device 7 then determines if the protocol information included in the received packet D1 and the information registered with the packet determination information 25 match with each other (step S17). When the protocol information in the received packet D1 matches with the information registered with the packet determination information 25 (when a result of step S17 is YES), the communication relay device 7 determines to send the responding instruction D2 to the image processing device 4, which has a connection to the internal network 5 (step S22). The protocol information in the received packet D1 may not match with the information registered with the packet determination information 25 (when a result of step S17 is NO). The communication relay device 7 then proceeds the process in step S18. Also when the information on the protocol is not included in the packet determination information 25 (when a result of step S16 is NO), the communication relay device 7 proceeds the process in step S18.

In step S18, the communication relay device 7 determines if the information on the user ID is included in the packet determination information 25 (step S18). The information on the IP address may be included (when a result of step S18 is YES). The communication relay device 7 then determines if the information on the user ID included in the received packet D1 and the information registered with the packet determination information 25 match with each other (step S19). When the user ID in the received packet D1 matches with the information registered with the packet determination information 25 (when a result of step S19 is YES), the communication relay device 7 determines to send the responding instruction D2 to the image processing device 4, which has a connection to the internal network 5 (step S22). The user ID in the received packet D1 may not match with the information registered with the packet determination information 25 (when a result of step S19 is NO). The communication relay device 7 then proceeds the process in step S20. Also when the information on the user ID is not configured with the packet determination information 25 (when a result of step S18 is NO), the communication relay device 7 proceeds the process in step S20.

In step S20, the communication relay device 7 determines if the information on the application is included in the packet determination information 25 (step S20). The information on the application may be included (when a result of step S20 is YES). The communication relay device 7 then determines if the application information included in the received packet D1 and the information registered with the packet determination information 25 match with each other (step S21). When the application information in the received packet D1 matches with the information registered with the packet determination information 25 (when a result of step S21 is YES), the communication relay device 7 determines to send the responding instruction D2 to the image processing device 4, which has a connection to the internal network 5 (step S22). The application information in the received packet D1 may not match with the information registered with the packet determination information 25 (when a result of step S21 is NO). The communication relay device 7 then determines not to send the responding instruction D2 and completes the responding instruction determination. Also, when the information on the application is not included in the packet determination information 25 (when a result of step S20 is NO), the communication relay device 7 determines not to send the responding instruction D2 and completes the responding instruction determination.

In the afore-described responding instruction determination, the information on the default gateway is determined at first. The information on the subnet mask is then determined. Specifically, the default gateway and the subnet mask are determined prior to the determination of the IP address or the user ID of the sender. It may be determined to send the responding instruction D2 only by determining the default gateway or the subnet mask. This may save time and effort of determining the IP address or the user ID separately. More specifically, the bigger company has more number of the information processing devices 10 connected to the company network 9 and more users. This lead more number of the IP addresses and/or the user IDs registered with the packet determination information 25. The number of the default gateway and/or the subnet mask, on the other hand, depends on the number of the network constructing the company network 9. It is general that the number of the default gateway and/or the subnet mask is less than the number of the registered IP address or user ID. It may be determined rapidly not to send the responding instruction D2 by determining the default gate way and/or the subnet mask before determining the IP address and/or the user ID of the sender.

In the afore-described responding instruction determination, not only the IP address of the sender but also the user ID are determined. The communication relay device 7 may enable the image processing device 4 to send the response information D3 after authenticating the user even the user is using another information processing device 10, which is different from the one he or she is usually using. The user may use his or her tablet terminal or the smartphone by having an access to a network in the company network 9. Even with the access to any network in the company network 9, his or her tablet terminal or the smartphone may detect the image processing device 4 and send the print job.

Back to FIG. 8, once the responding instruction determination (step S5) completes, the communication relay device 7 determines whether or not to send the responding instruction D2 (step S6). Specifically, the communication relay device 7 determines if it is determined in the responding instruction determination (step S5) to send the responding instruction D2. The responding instruction D2 may be sent (when a result of step S6 is YES). In this case, the communication relay device 7 brings the responding unit 22 into operation to send the responding instruction D2 to the image processing device 4 over the internal network 5 (step S7). The response information D3 is then sent from the image processing device 4 as the response to the packet D1. The information processing device 10, the sender of the packet D1, may detect the image processing device 4 with the response information D3 from the image processing device 4. The information processing device 10 is then enabled unicasting of the job such as the print job to the image processing device 4.

It may not be determined in the responding instruction determination (step S5) to send the responding instruction D2 (when a result of step S6 is NO). In this case, the communication relay device 7 completes the process without sending the responding instruction D2. The packet D1 received by the server 3 is then discarded, and no information is transmitted to the internal network 5.

When the information to determine the packet D1 is not registered with the packet determination information 25 (when a result of step S4 is NO), the communication relay device 7 brings the responding unit 22 into operation to send the responding instruction D2 to the image processing device 4 over the internal networks (step S7). Even in such a case, the response instruction D3 is sent by the image processing device 4 as a reply to the packet D1. The information processing device 10, the sender of the packet D1, may detect the image processing device 4 based on the response information D3 from the image processing device 4.

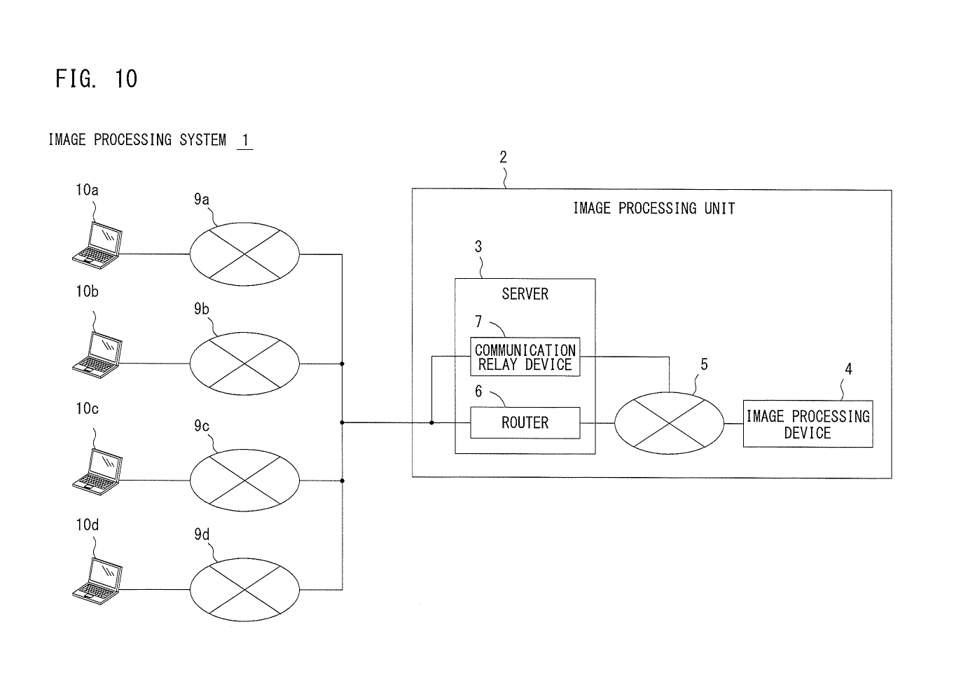

FIG. 10 illustrates an exemplary configuration of the image processing system 1 with the company network 9 including the multiple networks 9a, 9b, 9c and 9d. The multiple networks 9a, 9b, 9c and 9d may construct the company network 9 as illustrated in FIG. 10. Each of the multiple networks 9a, 9b, 9c and 9d has a different network address. Each of the multiple networks 9a, 9b, 9c and 9d has own default gateway. Even the subnet mask may differ for each network. The administrator then registers in advance the information on the default gateway and/or the subnet mask of each network 9a, 9b, 9c and 9d with the packet determination information 25. This allows authorization or restriction of the use of the image processing device 4 for each network constructing the company network 9. The communication relay device 7 may receive the packet D1 including the information on the default gateway and/or the subnet mask, which is not registered with the packet determination information 25. Even in such a case, if the packet D1 includes the IP address, the protocol, the user ID and the application, which is the information registered with the packet determination information 25, the responding instruction D2 in response to the packet D1 may be output to the image processing device 4, and the image processing device 4 may be enabled to send the response information D3. The communication relay device 7 in which the present preferred embodiment may be practiced determines if the packet D1 received over the company network 9 requires the response from the image processing device 4. The communication relay device 7 may conduct the determination according to the wide range of conditions configured in advance. It is not necessary for the user to configure the information such as the IP address of the image processing device 4 with each information processing device 10 connected to each of the multiple networks 9a, 9b, 9c and 9d, resulting in less burden on the user.

As described above, the communication relay device determines the packet received from the external network. If the communication relay device determines the packet should be blocked by the router, it sends the responding instruction to the device connected to the internal network. The communication relay device may enable the device to send the response information to the sender of the packet. The device connected to the external network may receive the response information to the command if it sends the broadcast command or the multicast command.

While the preferred embodiment of the present invention has been described above, the present invention is not limited to the preferred embodiment. Various modifications may be applied to the present invention.

In the above-described present preferred embodiment, for example, the single image processing device 4 is connected to the internal network 5 of the image processing unit 2. However, this is given not for limitation. The external image processing device may be connected to the internal network 5 besides the image processing device 4 included in the image processing unit 2. The number of the external image processing device connected to the internal network 5 does not have to be one. There may be more than two network connected external image processing devices. It is assumed, for example, the multiple image processing devices are connected to the internal network 5. When the communication relay device 7 determines the packet D1 received from the company network 9 requires the response from the image processing device then, the responding instruction D2 is sent to each of the multiple image processing devices. Hence, the information processing device 10 connected to the company network 9 broadcasts the packet D1 or is enabled multicasting of the packet D1, thereby receiving the response information D3 from each of the multiple image processing devices connected to the internal network 5.

In the above-described present preferred embodiment, for example, the information for identifying the packet whether it requires the response from the image processing device 4 is registered with the packet determination information 25. However, this is given not for limitation. The information for identifying the packet to which the image processing device 4 should not send the response may be registered with the packet determination information 25. In the case where the information included in the packet D1 received over the company network 9 is registered with the packet determination information 25, the communication relay device 7 does not send the responding instruction D2 to the image processing device 4. If the information included in the packet D1 is not registered with the packet determination information 25, the communication relay device 7 sends the responding instruction D2 to the image processing device 4.

The broadcast packet or the multicast packet may be received over the internet 12. As a setting of the router 11 connecting the company network 9 and the internet 12, the setting to pass the packet to the company network 9 may be configured. In such a case, the server 3 of the image processing unit 2 may receive the broadcast packet or the multicast packet over the internet 12. Information for further determining if the packet has passed the router 11 may be added together with the aforementioned information to the packet determination information 25. More specifically, the communication relay device 7 may refer the packet determination information 25, thereby determining if the packet D1 received over the company network 9 has passed through the router 11 and determining whether or not to send the response to the image processing device 4.

In the above-described present preferred embodiment, the device connected to the server 3 via the internal network 5 is the image processing device 4 as an example. The device connected to the server 3 via the internal network 5 does not always have to be the image processing device 4.

In the above-described present preferred embodiment, the predetermined program is run at the server 3 so that each of the router 6 and the communication relay device 7 is brought into operation. However, this is given not for limitation. Specifically, the router 6 and the communication relay device 7 with the image processing unit 2 may be a device constructed as an independent hardware.

Although the embodiment of the present invention has been described and illustrated in detail, the disclosed embodiments are made for purposes of illustration and example only and not limitation. The scope of the present invention should be interpreted by terms of the appended claims.

What is claimed is:

1. A communication relay device connected in parallel with a router that connects an external network and an internal network, comprising a hardware processor that:
determines if a packet received over said external network is blocked by said router when the packet is received; and
sends a responding instruction to a device connected to said internal network based on said received packet if said received packet is determined to be the packet that is blocked by said router.

2. The communication relay device according to claim 1, wherein
said hardware processor determines said received packet is the packet that is blocked by said router when a destination of said received packet is a broadcast address or a multicast address.

3. The communication relay device according to claim 1, wherein
said hardware processor sends the responding instruction on sending a response to a sender of said received packet via said router to said device.

4. The communication relay device according to claim 1, wherein
said hardware processor further determines if said received packet requires the response from said device when said received packet is determined as the packet that is blocked by said router, and
sends the responding instruction to said device if said received packet is determined as the packet that is blocked by said router and that requires the response from said device.

5. The communication relay device according to claim 4, wherein
the hardware processor further manages packet determination information with which the packet that requires the response from said device is registered in advance, and
analyzes information included in said received packet to determine if the packet is registered with said packet determination information, thereby determining whether or not said packet requires the response from said device when said received packet is determined to be the packet that is blocked by said router.

6. The communication relay device according to claim 5, wherein
said hardware processor further registers the packet that requires the response from said device with said packet determination information, and
registers the packet set by an administrator with said packet determination information.

7. The communication relay device according to claim 6, wherein
said hardware processor causes a predetermined display unit to display a packet setting screen when registering the packet with said packet determination information based on an instruction by the administrator.

8. The communication relay device according to claim 5, wherein
the packet including a specific IP address as the sender is registered with said packet determination information.

9. The communication relay device according to claim 5, wherein
the packet including a specific subnet mask as the sender is registered with said packet determination information.

10. The communication relay device according to claim 5, wherein
the packet going through a specific default gateway is registered with said packet determination information.

11. The communication relay device according to claim 5, wherein
the packet using a specific protocol is registered with said packet determination information.

12. The communication relay device according to claim 5, wherein
the packet sent by a specific application is registered with said packet determination information.

13. The communication relay device according to claim 5, wherein
the packet including a specific user information as the sender is registered with said packet determination information.

14. A server, comprising:
a communication relay device according to claim 1; and
a router connected in parallel with said communication relay device with connecting an external network and an internal network.

15. An image processing unit, comprising:
a server according to claim 14; and
an image processing device connected with said server over an internal network, wherein
said image processing device sends response information to an address designated in a responding instruction when receiving the responding instruction from a communication relay device in said server over said internal network.

16. The image processing unit according to claim 15, wherein
said image processing device sends said response information via a router in said server.

17. A non-transitory recording medium storing a computer readable program, execution of the computer readable program by a communication relay device that is connected in parallel with a router that connects an external network and an internal network, the program causing said communication relay device to perform:
(1) determining if a packet received over said external network is blocked by said router when the packet is received; and
(2) sending a responding instruction to a device connected to said internal network based on said received packet if said received packet is determined as the packet that is blocked by said router.

18. The non-transitory recording medium according to claim 17, wherein
said received packet is determined as the packet that is blocked by said router when a destination of said received packet is a broadcast address or a multicast address.

19. The non-transitory recording medium according to claim 17, wherein
the responding instruction on sending a response to a sender of said received packet via said router is sent to said device.

20. The non-transitory recording medium according to claim 17, wherein
said received packet is further determined if it requires the response from said device when said received packet is determined to be the packet that is blocked by said router, and
the responding instruction is sent to said device if said received packet is determined to be the packet that is blocked by said router and that requires the response from said device.

21. The non-transitory recording medium according to claim 20, wherein execution of the computer readable program by said information processing device causing said information processing device to further perform:
(3) managing packet determination information with which the packet that requires the response from said device is registered in advance, and
information included in said received packet is analyzed to determine if the packet is registered with said packet determination information so that whether or not said received packet requires the response from said device is determined when said received packet is determined to be the packet that is blocked by said router.
